(19) United States
(12) Patent Application Publication
(10) Pub. No.: US 2014/0089984 A1
(43) Pub. Date: Mar. 27, 2014

(54) CONTROL DEVICE, CONTROL METHOD, RECORDING DEVICE, RECORDING METHOD, AND PROGRAM

(71) Applicants: Takuya Fujita, Kanagawa (JP); Shouichi Doi, Kanagawa (JP); Takahito Migita, Tokyo (JP); HIroyuki Masuda, Kanagawa (JP); Tomohiro Tsunoda, Tokyo (JP)

(72) Inventors: Takuya Fujita, Kanagawa (JP); Shouichi Doi, Kanagawa (JP); Takahito Migita, Tokyo (JP); HIroyuki Masuda, Kanagawa (JP); Tomohiro Tsunoda, Tokyo (JP)

(73) Assignee: SONY CORPORATION, Tokyo (JP)

(21) Appl. No.: 14/116,230

(22) PCT Filed: May 22, 2012
(86) PCT No.: PCT/JP2012/063032

§ 371 Date: Nov. 7, 2013

(30) Foreign Application Priority Data
May 30, 2011 (JP) 2011-120805

(51) Int. Cl. H04N 21/472; H04N 21/482

(52) U.S. Cl. CPC H04N 21/47214; H04N 21/482
USPC 725/53; 725/58

(57) ABSTRACT

The present technique relates to a control device, a control method, a recording device, a recording method, and a program, which enable recording of all episodes of a series program.

A control device of a first aspect of the present technique includes an acquisition unit that acquires information of a program recorded in a recording device and a control unit that controls recording in the recording device so that an unrecorded episode is recorded when there is the unrecorded episode in a series program recorded in the recording device. The present technique can be applied to recording equipment.

### TECHNICAL FIELD

The present technique relates to, in particular, a control device, a control method, a recording device, a recording method, and a program, which enable recording of all episodes of a series program.

### BACKGROUND ART

The functions of recording devices such as a BD (Blu-ray Disc (trademark)) recorder are more and more improved.

Regarding a series program such as a serial drama that is broadcast at a scheduled time every week, if a recording reservation is set according to the first episode and a recording of all the series is specified, a user can cause all the episodes to be recorded without setting a recording reservation for each episode. After the broadcast of the final episode has been completed, all the recorded episodes are sometimes collectively stored in one BD and formed into a library.

As described above, there is a request that all the series of programs (TV programs) are stored and the user wants to watch the series sequentially from the first episode to the final episode.

### CITATION LIST

### Patent Document

Patent Document 1: JP 2010-056862 A
Patent Document 2: JP 2007-235799 A
Patent Document 3: JP 2009-522855 A

### SUMMARY OF THE INVENTION

### Problems to be Solved by the Invention

By the way, there is a case in which all the episodes of a series program cannot be recorded because the broadcast of the first episode has been completed when a user tries to start recording of the series program or the broadcast time is changed even though the recording reservation is set as described above.

In particular, in the case of a serial drama, if a viewer starts watching the series program from the middle, information is not inputted into the viewer in the order intended by a producer, so that a person alien to the viewer may appear as a known person in a certain episode. This may turns the viewer off.

Further, if watching interval is too long, such as, for example, the second episode is missed, the viewer forgets the previous story and cannot purely enjoy watching.

The present technique is made in view of such a situation and the present technique causes all the episodes of the series program to be able to be recorded.

### Solutions to Problems

A control device of a first aspect of the present technique includes: an acquisition unit that acquires information of a program recorded in a recording device; and a control unit that controls recording in the recording device so that an unrecorded episode is recorded when there is the unrecorded episode in a series program recorded in the recording device.

The control unit may determine whether or not the unrecorded episode is scheduled to be broadcast on the basis of EPG data and when determining that the unrecorded episode is scheduled to be broadcast, the control unit may transmit information including broadcast date and time of the unrecorded episode to the recording device and cause the recording device to set a recording reservation of the unrecorded episode.

When the control unit determines that the unrecorded episode is not scheduled to be broadcast, the control unit may transmit a request for broadcast of the unrecorded episode to a broadcast management device that manages broadcast of the series program.

The control unit may identify a scheduled recording completion date of the series program on the basis of EPG data and transmit information of the scheduled recording completion date to the recording device.

The control device may further include a search unit that searches for a first episode of a predetermined series program from among programs which are scheduled to be broadcast and whose program information is included in EPG data. In this case, the control unit may transmit information including broadcast date and time of the first episode of the predetermined series program to the recording device and cause the recording device to record the first episode.

The acquisition unit may acquire information of a program deleted in the recording device, and the control unit may control recording in the recording device so that the unrecorded episodes other than the episode deleted in the recording device among the unrecorded episodes are recorded.

A recording device of a second aspect of the present technique includes a transmission unit that transmits information of a recorded program to a control device, and a recording control unit that records an unrecorded episode according to control performed by the control device when there is the unrecorded episode in a recorded series program.

The recording control unit may set a recording reservation of the unrecorded episode on the basis of information including broadcast date and time of the unrecorded episode transmitted from the control device.

The recording device according may further include: a display control unit that displays a scheduled recording completion date of the series program on the basis of information transmitted from the control device.

The recording control unit may record a first episode of a predetermined series program on the basis of information including broadcast date and time of the first episode of the predetermined series program transmitted from the control device. In this case, the recording device may further include a display control unit that displays information guiding recording of the first episode and the subsequent episodes when recording of the first episode is performed.

The recording device may further include: a display control unit that displays information of the unrecorded episode in a format different from that of information of a recorded episode along with the information of the recorded episode.

The recording device may further include: a record control unit that causes a recording medium to record a recorded program; and a display control unit that displays information indicating that there is the unrecorded episode before the series program is recorded when the series program is selected as a program to be recorded in the recording medium.

The transmission unit may transmit information of a deleted program to the control device, and the recording control unit may record the unrecorded episodes other than the deleted episode among the unrecorded episodes according to control performed by the control device.

When it is necessary to subscribe to a predetermined service to receive the unrecorded episode, the transmission unit may transmit a request to subscribe to the service from a broadcast date of the unrecorded episode on the basis of information including the broadcast date of the unrecorded episode transmitted from the control device.

### Effects of the Invention

According to the present technique, it is possible to record all the episodes of the series program.

### BRIEF DESCRIPTION OF DRAWINGS

FIG. 1 is a diagram showing a configuration example of a recording control system according to an embodiment of the present technique.

FIG. 2 is a block diagram showing a configuration example of a recording device.

FIG. 3 is a block diagram showing a hardware configuration example of a recording control server.

FIG. 4 is a block diagram showing a functional configuration example of the recording control server.

FIG. 5 is a diagram showing an example of a process flow of an automatic complementary recording function.

FIG. 6 is a flowchart for explaining the process of the automatic complementary recording function.

FIG. 7 is a diagram showing a display example before the complementary recording is performed.

FIG. 8 is a diagram showing a display example after the complementary recording is performed.

FIG. 9 is a flowchart for explaining a process of a broadcast management device.

FIG. 10 is a diagram showing an example of a process flow of a recording completion time notification function.

FIG. 11 is a flowchart for explaining the process of the recording completion time notification function.

FIG. 12 is a diagram showing an example of a screen displayed by the recording completion time notification function.

FIG. 13 is a diagram showing an example of a process flow of an unrecorded episode notification function.

FIG. 14 is a flowchart for explaining the process of the unrecorded episode notification function.

FIG. 15 is a diagram showing an example of a screen displayed by the unrecorded episode notification function.

FIG. 16 is a diagram showing an example of a process flow of the unrecorded episode notification function during disk copy.

FIG. 17 is a flowchart for explaining the process of the unrecorded episode notification function during disk copy.

FIG. 18 is a diagram showing an example of a screen displayed by the unrecorded episode notification function during disk copy.

FIG. 19 is a diagram showing an example of a process flow of a series program guide function.

FIG. 20 is a flowchart for explaining the process of the series program guide function.

FIG. 21 is a diagram showing an example of a screen displayed by the series program guide function.

### MODE FOR CARRYING OUT THE INVENTION

Hereinafter, a mode for carrying out the present technique will be described. The order of description is as follows:

1. About Recording Control System

2. About Automatic complementary recording function

3. About Recording Completion Time Notification Function

4. About Unrecorded Episode Notification Function

5. About Unrecorded Episode Notification Function During Disk Copy

6. About Series Program Guide Function

7. Modified Example

### About Recording Control System

### Configuration of Recording Control System

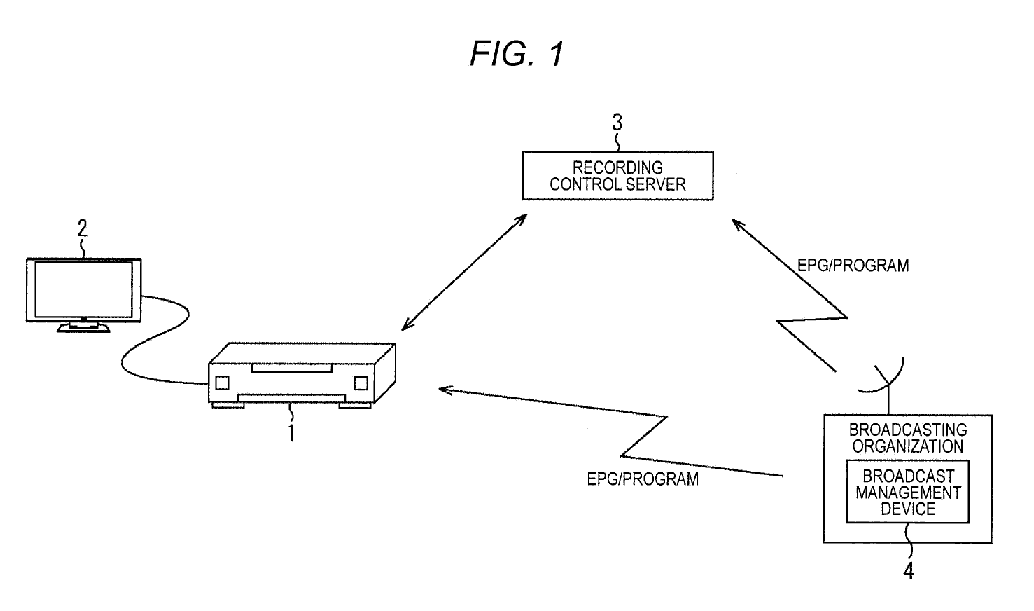

FIG. 1 is a diagram showing a configuration example of a recording control system according to an embodiment of the present technique.

The recording control system in FIG. 1 includes a recording device 1, a recording control server 3, and a broadcast management device 4. A TV 2 is connected to the recording device 1 through an HDMI (High Definition Multimedia Interface) cable or the like.

The recording device 1 is a recording device such as a BD recorder that is installed in the home of a user who is a program viewer. The recording device 1 has a function to receive and record various types of broadcasting such as terrestrial television broadcasting, satellite television broadcasting using BS (Broadcasting Satellite)/CS (Communications Satellite), CATV (Cable Television) broadcasting, and television broadcasting using the Internet. The recording device 1 also has a function to reproduce a program that is being broadcast or a program that has been recorded and cause video and audio of the program to be outputted from the TV 2.

As shown in FIG. 1, the recording device 1 receives programs broadcast by the broadcast management device 4 and records the program. The broadcasting of the broadcast management device 4 is, for example, the satellite television broadcasting. In addition to the programs, EPG (Electronic Program Guide) data is broadcast from the broadcast management device 4.

The recording device 1 and the recording control server 3 are connected through a network such as the Internet. The recording device 1 records programs according to control of the recording control server 3. For example, the recording device 1 records a series program such as a serial drama according to control of the recording control server 3.

One series program includes a plurality of programs with the same title. Hereinafter, each program included in a series program is referred to as an episode.

The recording device 1 manages a recording log and a viewing log and transmits the recording log and the viewing log to the recording control server 3 at a predetermined timing. The recording log includes the title, the broadcast time, the channel, ID, and the like of a recorded program which a user has recorded by operating the recording device 1. The viewing log includes the title, the broadcast time, the channel, ID, and the like of a viewed program which the user has viewed by operating the recording device 1.

The recording control server 3 determines a taste of the user of the recording device 1 on the basis of the recording log and the viewing log transmitted from the recording device 1 and identifies a series program according to the taste of the user of the recording device 1. In the recording control server 3, when at least one episode of a certain series program is recorded by the recording device 1, the series program is identified to be a series program according to the taste of the user of the recording device 1.

It is determined that a program recorded by the recording device 1 is an episode of a series program on the basis of the recording log transmitted from the recording device 1 and the EPG data provided from the broadcast management device 4.

In the recording control server 3, EPG data including program information of programs that were recorded in the past is accumulated in addition to EPG data including program information of programs that are scheduled to be broadcast. For example, as program information of each program, the EPG data includes information indicating whether or not the program is a series program, and further includes information indicating an episode number, information indicating that the program is the first episode, and information indicating that the program is the last episode if the program is a series program.

For example, the recording control server 3 searches for a program that is recorded in the recording device 1 on the basis of the title and the ID of the program from among programs whose program information is included in the EPG data. Further, the recording control server 3 determines whether or not information indicating that the program is a series program is included as the program information of the searched program. If the information indicating that the program is a series program is included, the recording control server 3 determines that the program that is recorded in the recording device 1 is an episode of a series program.

If the recording control server 3 detects that an episode of a series program is recorded in the recording device 1, the recording control server 3 determines whether or not the recording of the series program is completed, in other words, whether or not all the episodes have been recorded.

The EPG data includes information representing an episode number, information representing that an episode is the first episode, and information representing that an episode is the last episode, so that it is possible to identify how many episodes are included in one series program.

If the recording control server 3 determines that the recording of the series program is not completed, in other words, determines that there is an unrecorded episode, the recording control server 3 identifies the next broadcast date and time of the unrecorded episode on the basis of the EPG data. In particular, in the case of the satellite television broadcasting, the same series program is often broadcast repeatedly.

The unrecorded episode is an episode which was broadcast in the past but is not recorded in the recording device 1. Depending on the progress of the broadcast, the first or the last episode may be an unrecorded episode or a middle episode may be an unrecorded episode.

When the recording control server 3 identifies the broadcast date and time of the unrecorded episode on the basis of the EPG data, the recording control server 3 transmits information of the identified broadcast date and time to the recording device 1 and instructs the recording device 1 to record the unrecorded episode. In the recording device 1, a recording reservation is set according to the instruction from the recording control server 3, and when the broadcast is started, the unrecorded episode is recorded.

Thereby, in the recording device 1, the unrecorded episode is recorded and the recording of the series program is completed without a user's operation on the recording device 1.

In this way, in the recording device 1, various processing such as recording of a program is performed according to control of the recording control server 3. The details of each function implemented by the control of the recording control server 3 will be described later.

The broadcast management device 4 broadcasts a program by using the satellite television broadcasting. The broadcast management device 4 also organizes programs scheduled to be broadcast on the basis of information transmitted from the recording control server 3. The recording control server 3 and the broadcast management device 4 are also connected through a network. The EPG data may be supplied to the recording device 1 and the recording control server 3 through a network.

### Configuration of Each Device

Configurations of the recording device 1 and the recording control server 3 will be described.

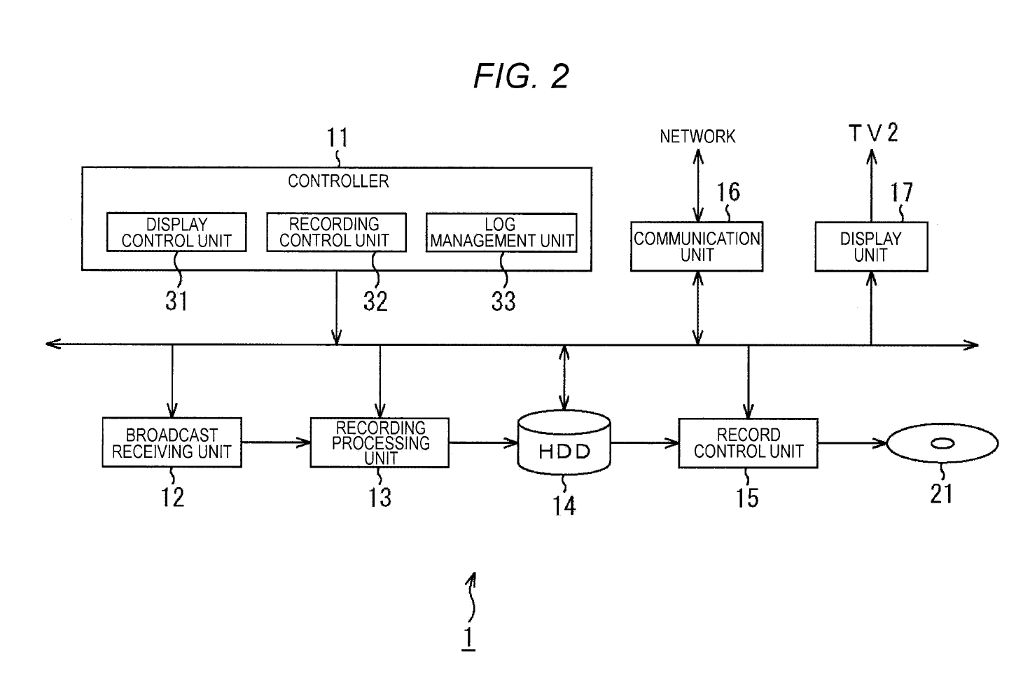

FIG. 2 is a block diagram showing a configuration example of the recording device 1. The recording device 1 includes a broadcast receiving unit 12, a recording processing unit 13, an HDD (Hard Disk Drive) 14, a record control unit 15, a communication unit 16, and a display unit 17, which are connected to a controller 11 through a bus.

The controller 11 includes a CPU (Central Processing Unit), a ROM (Read Only Memory), and a RAM (Random Access Memory) and controls the entire operation of the recording device 1 according to a predetermined program. The predetermined program is executed and thereby a display control unit 31, a recording control unit 32, and a log management unit 33 are implemented in the controller 11.

The display control unit 31 controls the display unit 17 and causes the TV 2 to display various information. For example, the display control unit 31 causes the TV 2 to display information of recorded programs and information of scheduled recording completion date of a series program.

The recording control unit 32 controls the recording processing unit 13 and causes the recording processing unit 13 to record a program. For example, the recording control unit 32 sets a recording reservation of a program on the basis of information transmitted from the recording control server 3 and when the broadcast of the program for which the recording reservation is set is started, the recording control unit 32 causes the recording processing unit 13 to record the program. Further, the recording control unit 32 causes the recording processing unit 13 to record a program specified by a user.

The log management unit 33 monitors the recording performed by the recording control unit 32, generates a recording log each time a program is recorded, and manages the recording log by storing the recording log in the HDD 14 or the like.

The broadcast receiving unit 12 receives a broadcast program. The broadcast receiving unit 12 performs various processing such as demodulation processing on a received signal and outputs data of the program to the recording processing unit 13.

The recording processing unit 13 encodes the data supplied from the broadcast receiving unit 12 by a predetermined method and causes the HDD 14 to record the encoded data of the program. Instead of the HDD 14, another storage medium such as a flash memory may be used to record the program.

The record control unit 15 causes an optical disk 21 to record (copy) the recorded program that is recorded in the HDD 14. The optical disk 21 is an optical disk such as a BD that is inserted in a drive of the recording device 1. Instead of the optical disk 21, another removable medium such as a memory card may be used as a copy destination of the recorded program.

The communication unit 16 communicates with the recording control server 3 through a network according to controls of each unit of the controller 11.

The display unit 17 outputs information supplied from the display control unit 31 to the TV 2 and causes the TV 2 to display various information. In the TV 2, a display device such as an LCD (Liquid Crystal Display) is provided.

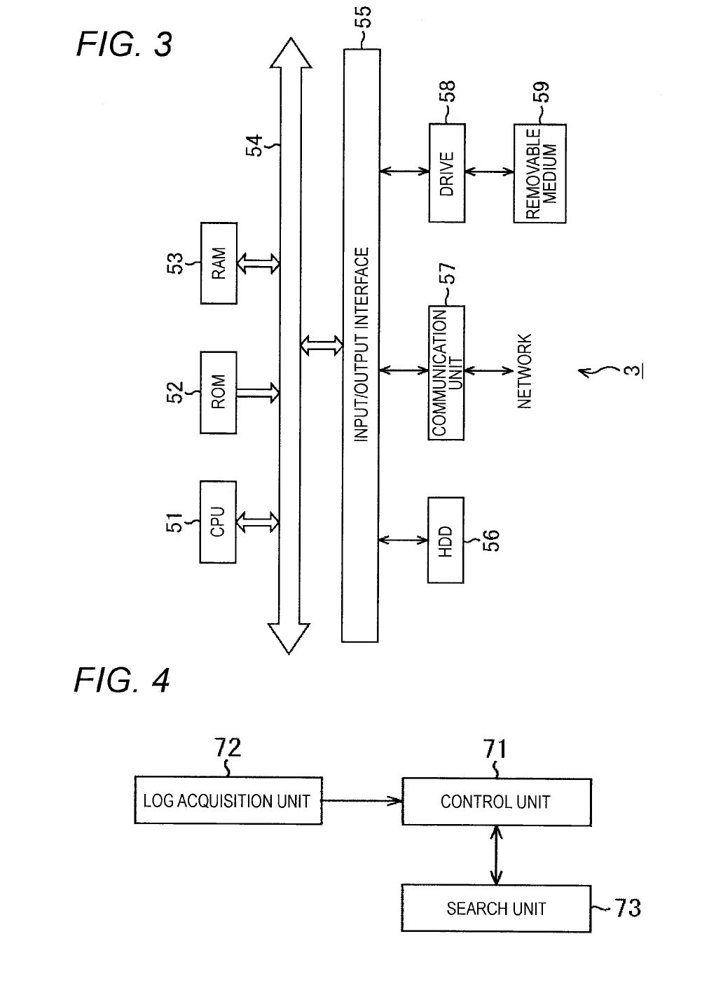

FIG. 3 is a block diagram showing a hardware configuration example of the recording control server 3.

A CPU 51, a ROM 52, and a RAM 53 are connected to each other by a bus 54. Further, an input/output interface 55 is connected to the bus 54. An HDD 56, a communication unit 57 including a network interface, and a drive 58 that drives a removable medium 59 are connected to the input/output interface 55.

In the HDD 56, various information such as the EPG data and the recording log transmitted from the recording device 1 is recorded. The communication unit 57 communicates with the recording device 1 and the broadcast management device 4 through a network.

The broadcast management device 4 has the same configuration as that of the recording control server 3 shown in FIG. 3. The recording control server 3 and the broadcast management device 4 may be configured by one computer as shown in FIG. 3 or may be configured by a plurality of computers.

FIG. 4 is a block diagram showing a functional configuration example of the recording control server 3. At least a part of the functional units shown in FIG. 4 is implemented by the CPU 51 in FIG. 3 which executes a predetermined program.

In the recording control server 3, a control unit 71, a log acquisition unit 72, and a search unit 73 are implemented.

The control unit 71 controls recording in the recording device 1. For example, the control unit 71 identifies an unrecorded episode on the basis of a recording log acquired by the log acquisition unit 72. The control unit 71 transmits information instructing recording of the unrecorded episode to the recording device 1 and causes the recording device 1 to set a recording reservation. Further, the control unit 71 transmits information instructing recording of a program searched by the search unit 73 to the recording device 1 and causes the recording device 1 to set a recording reservation. The communication with the recording device 1 is performed by the control unit 71 controlling the communication unit 57.

The log acquisition unit 72 acquires a recording log transmitted from the recording device 1. The communication with the recording device 1 is performed by the log acquisition unit 72 controlling the communication unit 57. The log acquisition unit 72 outputs the recording log to the control unit 71.

The search unit 73 searches for a program to be recorded by the recording device 1 from among programs scheduled to be broadcast on the basis of the EPG data. The search unit 73 outputs information of the searched program to the control unit 71.

### About Automatic Complementary Recording Function

Here, an automatic complementary recording function will be described.

The automatic complementary recording function is a function to record an unrecorded episode so that a series program is complemented and completes recording of the series program. The automatic complementary recording function works when the recording is started from a middle episode or a certain episode is not recorded due to a change of broadcast time even though a series program is recorded in the recording device 1.

When the recording is started from a middle episode, the episodes to be recorded by the automatic complementary recording function are episodes whose episode number is smaller than that of the middle episode where the recording is first performed. When a certain episode is not recorded due to a change of broadcast time, the episode to be recorded by the automatic complementary recording function is the episode that is not recorded.

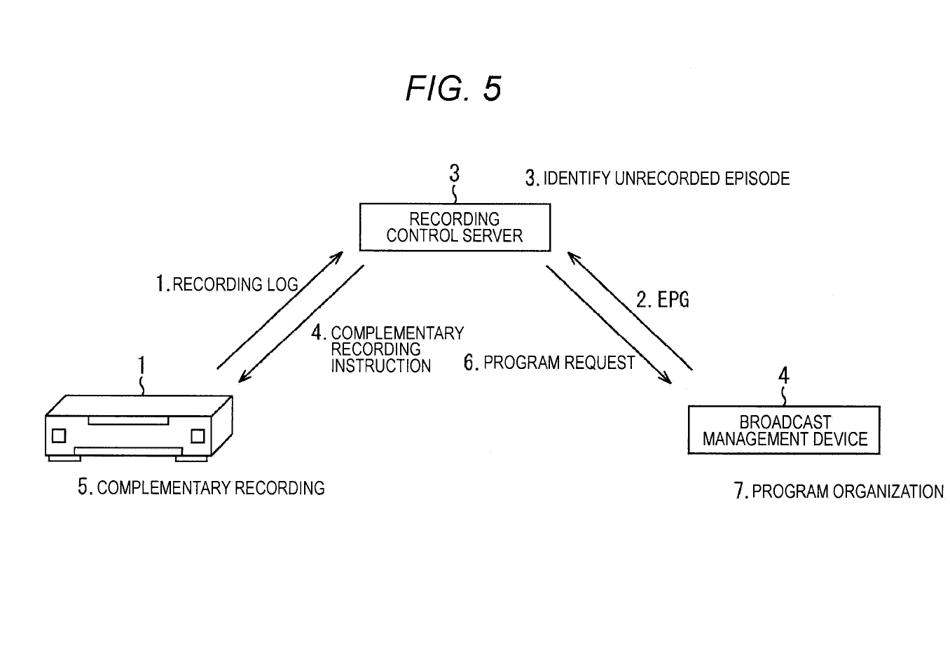

FIG. 5 is a diagram showing an example of a process flow of the automatic complementary recording function. Each process is performed in parallel with another process or performed before or after another process, as appropriate.

The recording device 1 generates a recording log and records the recording log. As shown as the process 1, the recording device 1 transmits the recording log to the recording control server 3 at a predetermined timing, such as after the recording is completed.

As shown as the process 2, the broadcast management device 4 transmits the EPG data to the recording control server 3.

The recording control server 3, which has received the recording log and the EPG data, confirms that a series program is recorded in the recording device 1 on the basis of the received information. Further, as shown as the process 3, the recording control server 3 identifies an unrecorded episode.

The recording control server 3 determines whether or not the unrecorded episode is scheduled to be broadcast on the basis of the EPG data. If the recording control server 3 determines that the unrecorded episode is scheduled to be broadcast, as shown as the process 4, the recording control server 3 instructs the recording device 1 to perform recording (complementary recording) of the unrecorded episode. The instruction transmitted from the recording control server 3 to the recording device 1 includes information such as the broadcast date and time and the channel of the unrecorded episode included in the EPG data.

The recording device 1 receives the instruction from the recording control server 3 and sets a recording reservation of the episode instructed to be recorded. When the broadcast of the unrecorded episode is started, as shown as the process 5, the recording device 1 records the unrecorded episode.

On the other hand, if the recording control server 3 determines that the unrecorded episode is not scheduled to be broadcast, as shown as the process 6, the recording control server 3 transmits a program request, which is a request for broadcast of the unrecorded episode, to the broadcast management device 4. The program request transmitted from the recording control server 3 to the broadcast management device 4 includes information such as the title, the episode number, and the ID of the unrecorded episode included in the EPG data.

The broadcast management device 4 receives the program request from the recording control server 3 and stores the program request. For example, if a predetermined number or more of program requests that request broadcast of the same program are transmitted, as shown as the process 7, the broadcast management device 4 organizes programs so that a broadcast slot is assigned to the program for which the predetermined number or more of program requests are transmitted.

For example, the broadcast management device 4 secures in advance a period of time, where the number of viewers is small, such as a period of time in the small hours, as a period of time for a program for which the predetermined number or more of program requests are transmitted. A broadcast slot in the period of time secured in advance is used for the broadcast of the unrecorded episode for which many program requests are transmitted.

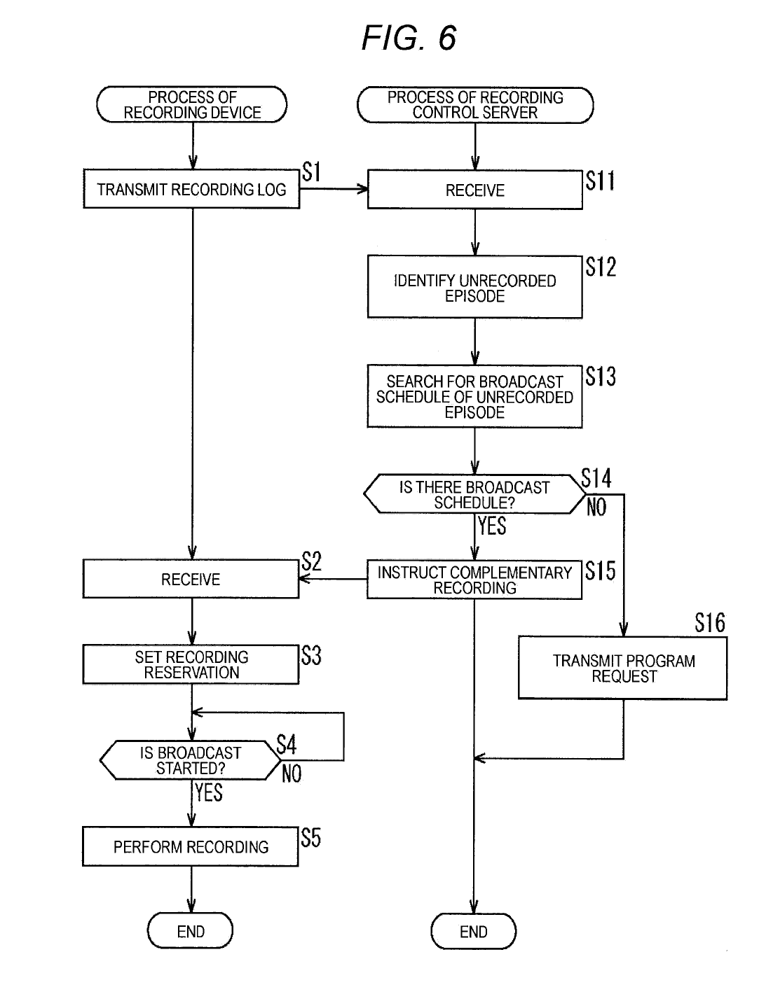

Here, the processes of the recording device 1, which records a program by the automatic complementary recording function, and the recording control server 3 will be described with reference to a flowchart in FIG. 6.

The processes in FIG. 6 are started, for example, when the recording log is accumulated in the recording device 1 and the EPG data is accumulated in the recording control server 3.

In step S1, the log management unit 33 (FIG. 2) of the recording device 1 transmits the recording log accumulated in the HDD 14 or the like to the recording control server 3.

In step S11, the log acquisition unit 72 (FIG. 4) of the recording control server 3 receives and acquires the recording log transmitted from the recording device 1. The log acquisition unit 72 outputs the acquired recording log to the control unit 71.

In step S12, the control unit 71 identifies an unrecorded episode on the basis of the recording log and the EPG data as described above.

In step S13, the search unit 73 searches for a broadcast schedule of the unrecorded episode identified by the control unit 71. If there is the broadcast schedule of the unrecorded episode, the search unit 73 outputs information of the unrecorded episode included in the EPG data to the control unit 71.

In step S14, the control unit 71 determines whether or not there is the broadcast schedule of the unrecorded episode on the basis of the search result of the search unit 73.

If the control unit 71 determines that there is the broadcast schedule in step S14, in step S15, the control unit 71 transmits information including the broadcast date and time and the channel of the unrecorded episode to the recording device 1 and instructs the recording device 1 to perform complementary recording of the unrecorded episode.

On the other hand, if the control unit 71 determines that there is no broadcast schedule in step S14, in step S16, the control unit 71 transmits a program request including information such as the title, the episode number, the ID of the unrecorded episode to the broadcast management device 4.

In step S2, the recording control unit 32 of the recording device 1 receives an instruction of complementary recording from the recording control server 3, and in step S3, the recording control unit 32 sets a recording reservation of the unrecorded episode instructed to be recorded.

In step S4, the recording control unit 32 determines whether or not it is the broadcast start time of the unrecorded episode and waits until the recording control unit 32 determines that it is the broadcast start time.

If the recording control unit 32 determines that it is the broadcast start time of the unrecorded episode in step S4, in step S5, the recording control unit 32 controls the broadcast receiving unit 12 and the recording processing unit 13 and causes the broadcast receiving unit 12 and the recording processing unit 13 to record the unrecorded episode whose broadcast is started. Thereafter, the process ends.

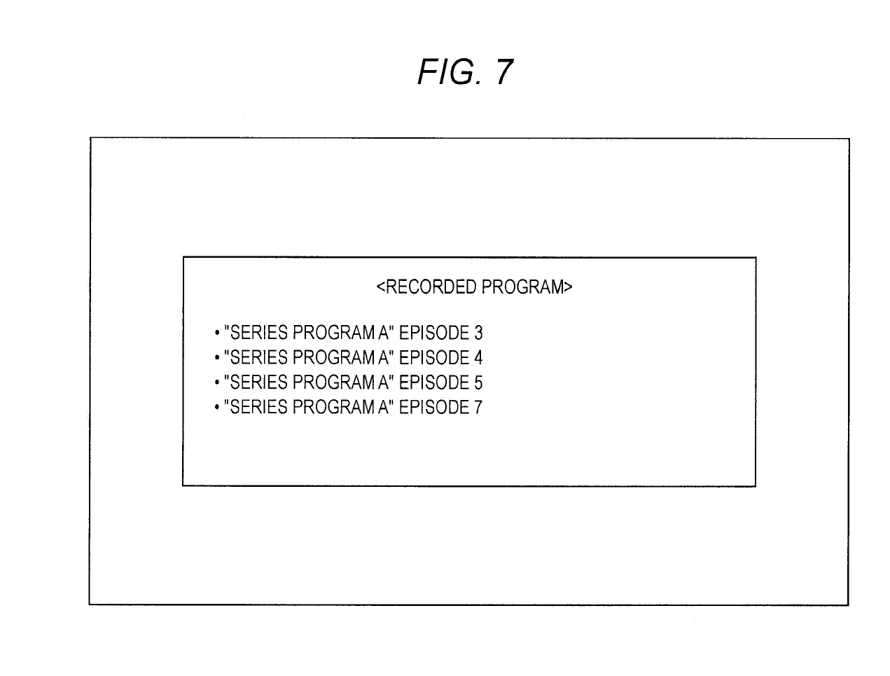

FIG. 7 is a diagram showing a display example of recorded programs before the complementary recording is performed.

The screen shown in FIG. 7 is displayed, for example, when a user instructs display of a list of recorded programs. When the user instructs display of a list of recorded programs, the display control unit 31 accesses the HDD 14 and acquires information of recorded programs. The display control unit 31 causes the TV 2 to display information of the recorded programs on the basis of the acquired information.

In the example of FIG. 7, episodes 3, 4, 5, and 7 of a “series program A”, which is a series program, are displayed as the recorded programs. When the episode 7 is the last episode of the “series program A”, the episodes 1, 2, and 6 are unrecorded episodes.

The “series program A” is the title of the series program whose recording was performed. The user can reproduce a selected episode and/or store the selected episode in the optical disk 21 by selecting a predetermined episode from the screen shown in FIG. 7.

When the programs are recorded as shown in FIG. 7, the recording device 1 transmits a recording log indicating that the episodes 3, 4, 5, and 7 of the “series program A” have been recorded to the recording control server 3. In the recording device 1, the complementary recording of the episodes 1, 2, and 6 is performed according to control of the recording control server 3.

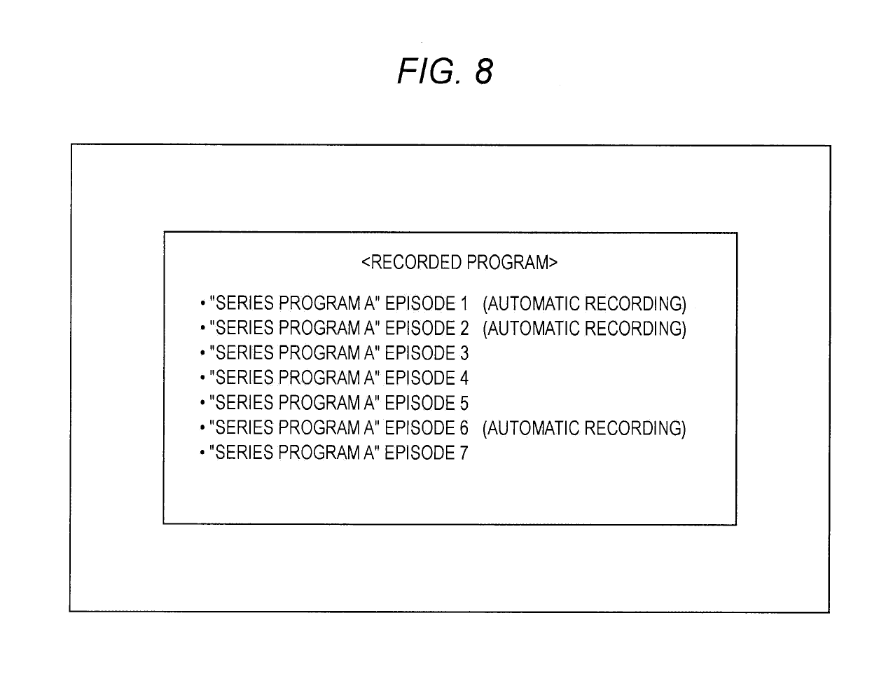

FIG. 8 is a diagram showing a display example of recorded programs after the complementary recording is performed.

In the example of FIG. 8, the episodes 1 to 7 of the “series program A” are displayed as the recorded programs. The characters “(complementary recording)”, which are information indicating that the episodes 1, 2, and 6 are recorded by the complementary recording, are displayed adjacent to the episodes 1, 2, and 6, which are recorded by the complementary recording.

The user of the recording device 1 can know that the episodes 1, 2, and 6 of the “series program A” are programs that are automatically recorded by the complementary recording from the characters “(complementary recording)”. Further, the user can reproduce the automatically recorded episodes by selecting the episodes 1, 2, and 6 of the “series program A”. Further, the user can select the episodes 1 to 7 of the “series program A” and record all the episodes of the “series program A” in the optical disk 21 on a series basis.

By the process described above, the recording device 1 can complementarily record the unrecorded episodes without user's operation, so that the recording device 1 can record all the episodes and complete the recording of the series program. Further, the user can cause the unrecorded episodes to be automatically recorded without setting a recording reservation by checking the broadcast schedule by himself or herself.

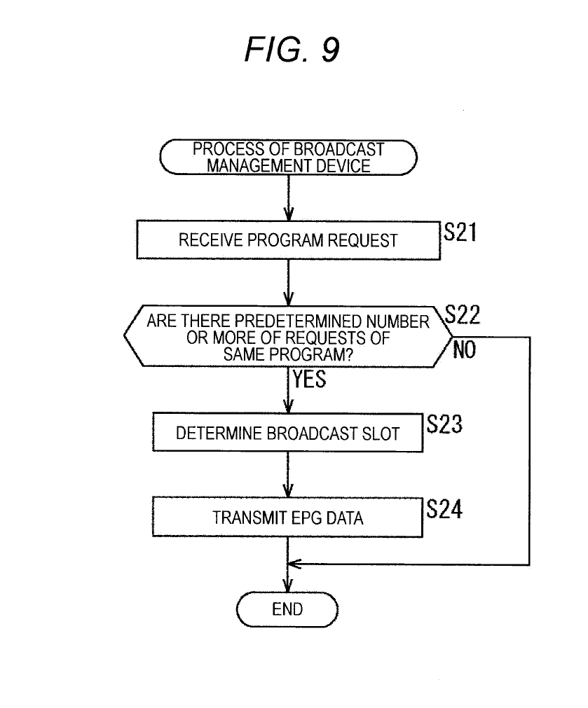

The process of the broadcast management device 4 that receives the program request transmitted from the recording control server 3 will be described with reference to a flowchart in FIG. 9. The process in FIG. 9 is started when a program request for a predetermined program is transmitted from the recording control server 3.

In step S21, the broadcast management device 4 receives the program request transmitted from the recording control server 3. The received program request is recorded in the HDD of the broadcast management device 4.

In step S22, the broadcast management device 4 determines whether or not a predetermined number or more of program requests that request broadcast of the same program are transmitted.

If the broadcast management device 4 determines that the predetermined number or more of program requests that request broadcast of the same program are transmitted in step S22, in step S23, the broadcast management device 4 determines a broadcast slot of the program for which the predetermined number or more of program requests are transmitted. As described above, a broadcast slot in the small hours or the like is used as a broadcast slot of the program for which the predetermined number or more of program requests are transmitted.

In step S24, the broadcast management device 4 transmits the EPG data including information of the program for which the predetermined number or more of program requests are transmitted as information of programs scheduled to be broadcast. After the EPG data is transmitted or when it is determined that the predetermined number or more of program requests that request broadcast of the same program are not transmitted in step S22, the process ends.

In the recording control server 3 which receives new EPG data, the processes of step S13 and the subsequent steps in FIG. 6 are performed, so that the complementary recording of the program for which the predetermined number or more of program requests are transmitted, that is, the complementary recording of an unrecorded episode in the recording device 1, is performed.

In step S13 in FIG. 6, the broadcast schedule of the unrecorded episode whose broadcast slot is newly determined by program organization is searched for by the recording control server 3, and in step S15, the complementary recording of the unrecorded episode is instructed to the recording device 1. In the recording device 1, a recording reservation is set in step S3 according to the instruction from the recording control server 3, and when the broadcast is started, in step S5, the unrecorded episode whose broadcast slot is newly determined by program organization is recorded.

In this way, when the unrecorded episode is not scheduled to be broadcast, the program request is automatically transmitted from the recording control server 3, so that the user of the recording device 1 need not request a broadcasting organization to broadcast the unrecorded episode.

### About Complementary Recording Using Deletion Log

The complementary recording may not need to be performed for an episode which is consciously deleted by the user and becomes an unrecorded episode. An episode that was recorded in the past but deleted by the user after viewing or the like is managed by a deletion log.

The log management unit 33 of the recording device 1 records the recording log, and when deletion of a recorded episode is instructed by the user, the log management unit 33 deletes the instructed episode and creates and records a deletion log. The deletion log includes the title, the episode number, the ID, and the like of the deleted episode. The log management unit 33 transmits the deletion log to the recording control server 3 along with the recording log.

The log acquisition unit 72 of the recording control server 3 receives and acquires the recording log and the deletion log transmitted from the control device 1. The control unit 71 of the recording control server 3 confirms that a series program is recorded in the recording device 1 on the basis of the recording log and the EPG data. The control unit 71 identifies unrecorded episodes other than the episodes explicitly deleted by the user from among the unrecorded episodes on the basis of the deletion log as episodes to be complementarily recorded. When an episode identified as an episode to be complementarily recorded is scheduled to be broadcast, the control unit 71 instructs the recording device 1 to complementarily record the unrecorded episode.

The recording control unit 32 of the recording device 1 receives the instruction from the recording control server 3, sets a recording reservation of the unrecorded episode instructed to be recorded, and records the unrecorded episode when the broadcast is started.

Thereby, it is possible to prevent the episode consciously deleted by the user from being automatically recorded as an unrecorded episode.

The determination whether to exclude an episode consciously deleted by the user from the episodes to be complementarily recorded may be performed by the recording device 1 instead of the recording control server 3.

In this case, the log management unit 33 of the recording device 1 records the recording log, and when deletion of a recorded episode is instructed by the user, the log management unit 33 deletes the instructed episode and creates and records a deletion log. The log management unit 33 does not transmit the deletion log and transmits the recording log to the recording control server 3.

The log acquisition unit 72 of the recording control server 3 receives and acquires the recording log transmitted from the control device 1. The control unit 71 of the recording control server 3 confirms that a series program is recorded in the recording device 1 on the basis of the recording log and the EPG data. When an unrecorded episode is scheduled to be broadcast, the control unit 71 instructs the recording device 1 to complementarily record the unrecorded episode.

The recording control unit 32 of the recording device 1 receives the instruction from the recording control server 3 and identifies unrecorded episodes other than the episodes explicitly deleted by the user from among the unrecorded episodes instructed to be recorded on the basis of the deletion log as episodes to be complementarily recorded. The recording control unit 32 sets a recording reservation of an unrecorded episode identified as an episode to be complementarily recorded and records the unrecorded episode when the broadcast is started.

In this way, it is possible to cause the recording device 1 to perform the determination whether to exclude an episode consciously deleted by the user from the episodes to be complementarily recorded.

### About Recording Completion Time Notification Function

Next, a recording completion time notification function will be described.

The recording completion time notification function is a function to notify the user of the time when the recording of the series program is completed. The recording completion time notification function works when a predetermined episode of the series program is recorded.

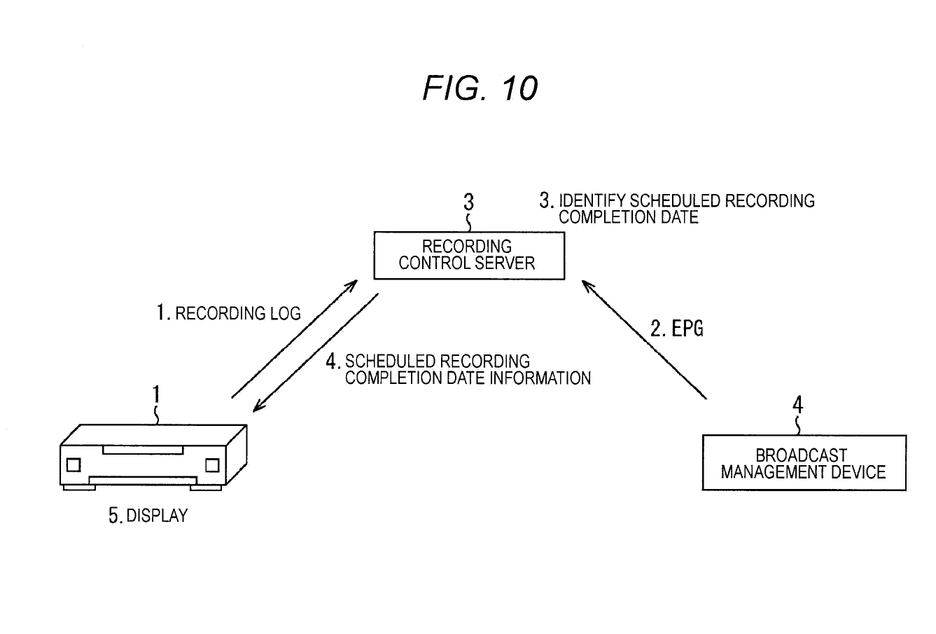

FIG. 10 is a diagram showing an example of a process flow of the recording completion time notification function. Each process is performed in parallel with another process or performed before or after another process, as appropriate.

The recording device 1 generates a recording log and records the recording log every time performing recording. As shown as the process 1, the recording device 1 transmits the recording log to the recording control server 3 at a predetermined timing, such as after the recording is completed.

As shown as the process 2, the broadcast management device 4 transmits the EPG data to the recording control server 3.

The recording control server 3, which has received the recording log and the EPG data, confirms that a series program is recorded in the recording device 1 on the basis of the received information. As shown as the process 3, the recording control server 3 checks the broadcast schedule of the series program whose recording is performed in the recording device 1 on the basis of the EPG data and identifies a scheduled recording completion date of the series program.

For example, when the recording of the series program is performed in a state in which there is no unrecorded episode, the scheduled broadcast date of the last episode is the scheduled recording completion date of the series program. When there is an unrecorded episode and the unrecorded episode is complementarily recorded by the automatic complementary recording function, the scheduled date when the complementary recording of the unrecorded episode is performed (the scheduled broadcast date of the unrecorded episode) is the scheduled recording completion date of the series program.

As shown as the process 4, the recording control server 3 transmits information of the scheduled recording completion date to the recording device 1.

The recording device 1 receives the information from the recording control server 3, and as shown as the process 5, displays the scheduled recording completion date of the series program.

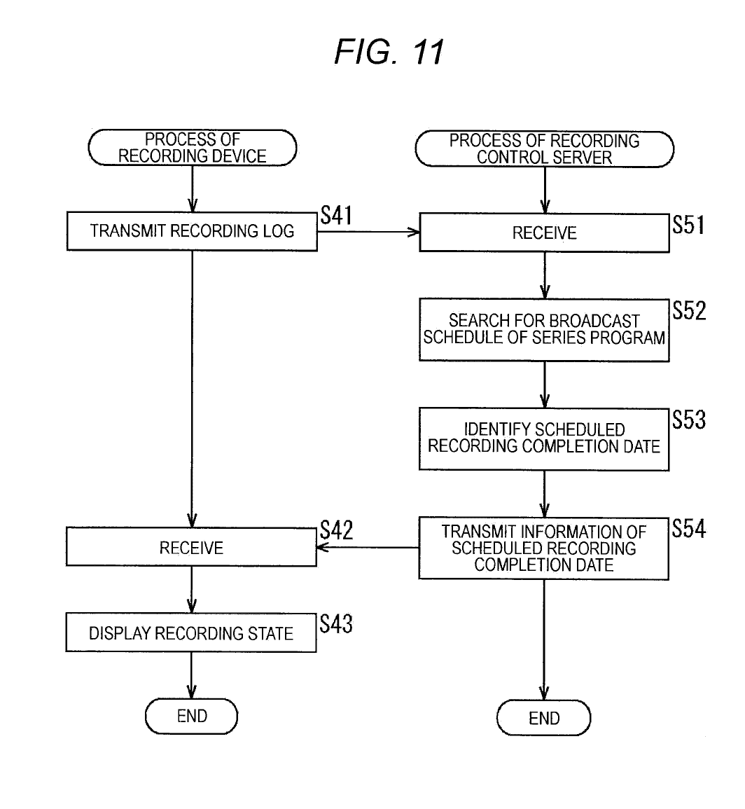

Here, the processes of the recording device 1, which notifies the user of the scheduled recording completion date by the recording completion time notification function, and the recording control server 3 will be described with reference to a flowchart in FIG. 11.

The processes in FIG. 11 are started, for example, in a state in which the recording log is accumulated in the recording device 1 and the EPG data is accumulated in the recording control server 3, when the user of the recording device 1 instructs display of a recording state.

In step S41, the log management unit 33 of the recording device 1 transmits the recording log accumulated in the HDD 14 or the like to the recording control server 3.

In step S51, the log acquisition unit 72 of the recording control server 3 receives and acquires the recording log transmitted from the recording device 1. The control unit 71 identifies that a series program is recorded in the recording device 1 on the basis of the recording log and the EPG data.

In step S52, the search unit 73 searches for a broadcast schedule of the series program recorded in the recording device 1. Information of the scheduled broadcast date of each episode of the series program recorded in the recording device 1 is acquired from the EPG data by the search unit 73.

In step S53, the control unit 71 identifies the scheduled recording completion date of the series program recorded in the recording device 1 on the basis of the information acquired by the search of the search unit 73.

In step S54, the control unit 71 transmits information of the scheduled recording completion date of the series program recorded in the recording device 1 to the recording device 1.

In step S42, the display control unit 31 of the recording device 1 receives the information from the recording control server 3.

In step S43, the display control unit 31 causes the TV 2 to display the information of the scheduled recording completion date of the series program as a recording state and ends the process.

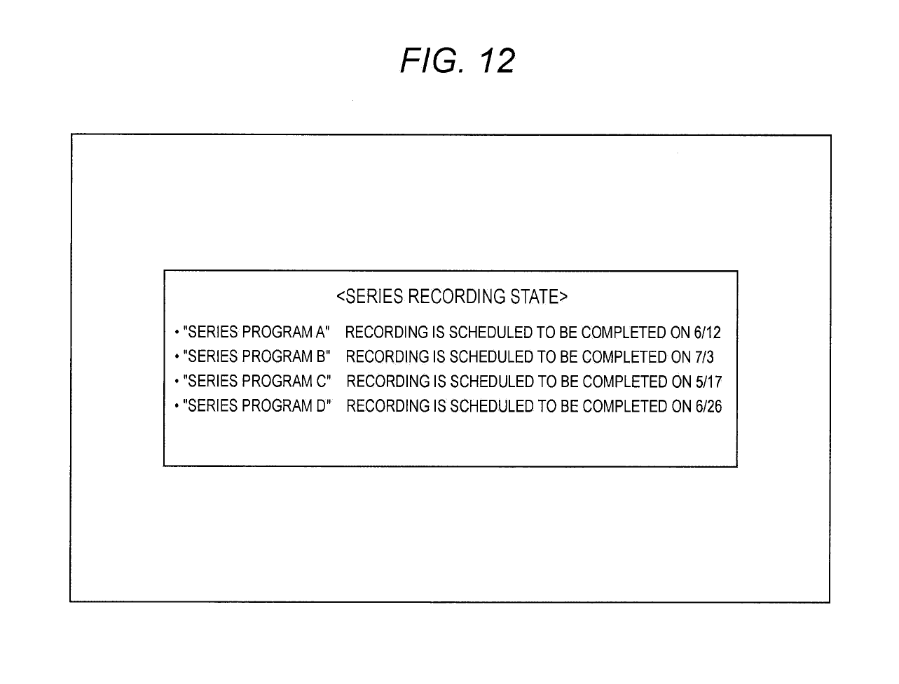

FIG. 12 is a diagram showing an example of the scheduled recording completion date displayed by the recording completion time notification function.

In the example of FIG. 12, the scheduled recording completion date of the “series program A”, which is a series program, is displayed as 12 June and the scheduled recording completion date of the “series program B” is displayed as 3 July. In the same manner, the scheduled recording completion dates of the “series program C” and the “series program D” are displayed.

Each scheduled recording completion date is the scheduled broadcast date of the last episode or the scheduled date when the complementary recording of the unrecorded episode is performed (the scheduled broadcast date of the unrecorded episode). When there is a plurality of unrecorded episodes, the scheduled recording completion date is a scheduled date when the complementary recording of an episode whose episode number is the greatest among the unrecorded episodes is performed.

Thereby, the user of the recording device 1 can check the date when the series program which the user records is completed. For example, when the broadcast service provided by the broadcasting organization, which is a manager of the broadcast management device 4, is a service contracted on a monthly basis, the user of the recording device 1 can know how many months of contracts are required from now on to complete the recording of the series program.

### About Unrecorded Episode Notification Function

Next, an unrecorded episode notification function will be described.

The unrecorded episode notification function is a function to notify that there is an unrecorded episode when there is an unrecorded episode. The notification that there is an unrecorded episode is performed by displaying information of the unrecorded episode along with information of recorded episodes.

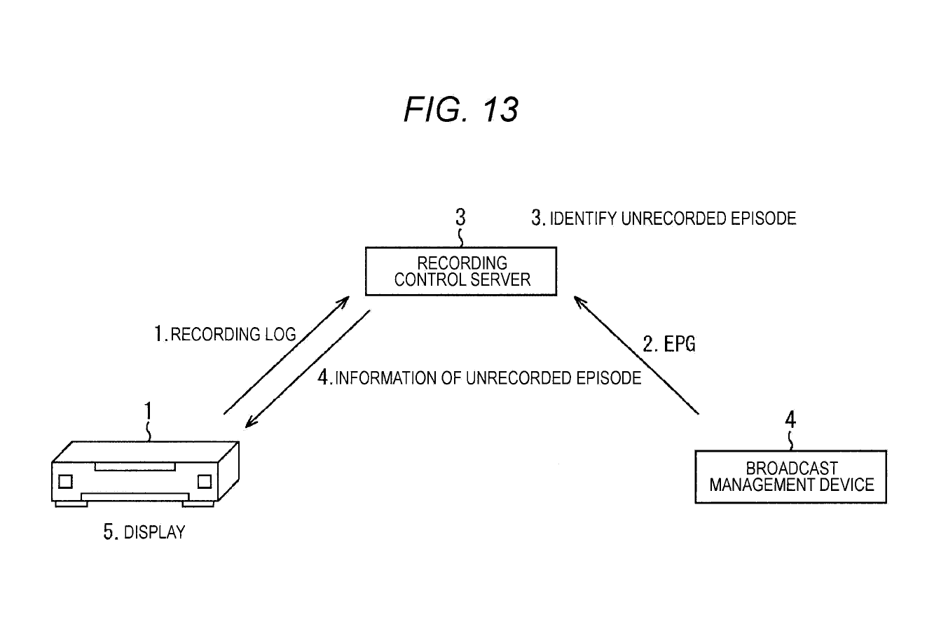

FIG. 13 is a diagram showing an example of a process flow of the unrecorded episode notification function. Each process is performed in parallel with another process or performed before or after another process, as appropriate.

The recording device 1 generates a recording log and records the recording log every time performing recording. As shown as the process 1, the recording device 1 transmits the recording log to the recording control server 3 at a predetermined timing, such as after the recording is completed.

As shown as the process 2, the broadcast management device 4 transmits the EPG data to the recording control server 3.

The recording control server 3, which has received the recording log and the EPG data, confirms that a series program is recorded in the recording device 1 on the basis of the received information. Further, as shown as the process 3, the recording control server 3 identifies an unrecorded episode.

The recording control server 3 acquires information of the unrecorded episode from the EPG data, and as shown as the process 4, transmits the information to the recording device 1. The information transmitted to the recording device 1 includes information such as the title, the episode number, information indicating whether or not the episode is a program of PPV (Pay Per View), the scheduled broadcast date, and the channel of the unrecorded episode.

The recording device 1 receives the information from the recording control server 3, and as shown as the process 5, displays the information of the unrecorded episode along with the information of recorded episodes.

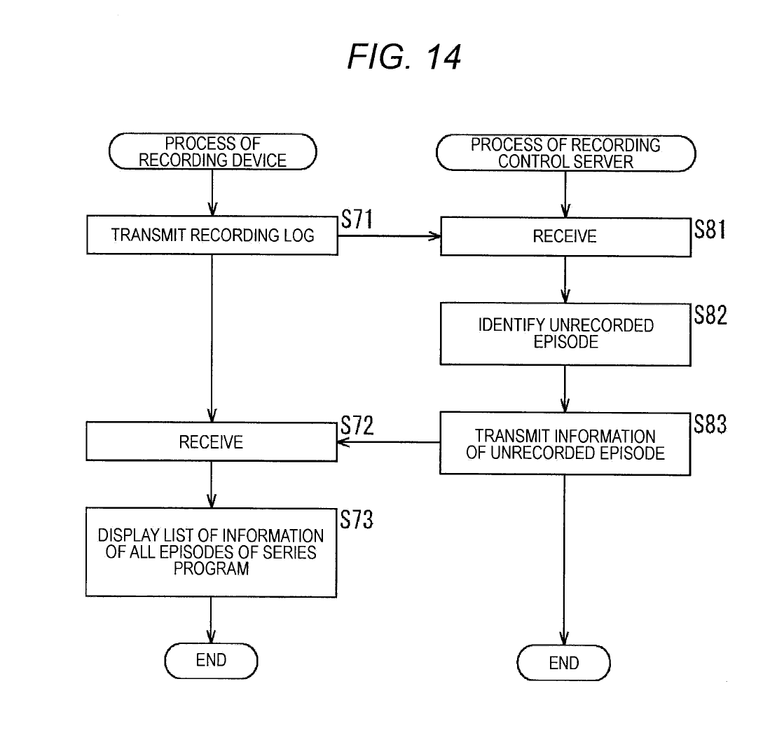

Here, the processes of the recording device 1, which notifies the user that there is an unrecorded episode by the unrecorded episode notification function, and the recording control server 3 will be described with reference to a flowchart in FIG. 14.

The processes in FIG. 14 are started, for example, in a state in which the recording log is accumulated in the recording device 1 and the EPG data is accumulated in the recording control server 3, when the user of the recording device 1 instructs display of a recording state of a certain series program.

In step S71, the log management unit 33 of the recording device 1 transmits the recording log accumulated in the HDD 14 or the like to the recording control server 3.

In step S81, the log acquisition unit 72 of the recording control server 3 receives and acquires the recording log transmitted from the recording device 1.

In step S82, the control unit 71 confirms that a series program is recorded in the recording device 1 on the basis of the recording log and the EPG data and identifies unrecorded episodes.

In step S83, the control unit 71 transmits information of the unrecorded episodes included in the EPG data to the recording device 1.

In step S72, the display control unit 31 of the recording device 1 receives the information from the recording control server 3.

In step S73, the display control unit 31 causes the TV 2 to display a list of information of all the episodes including recorded episodes and unrecorded episodes and then ends the process. The information of the recorded episodes is read from the HDD 14 and used to display the list.

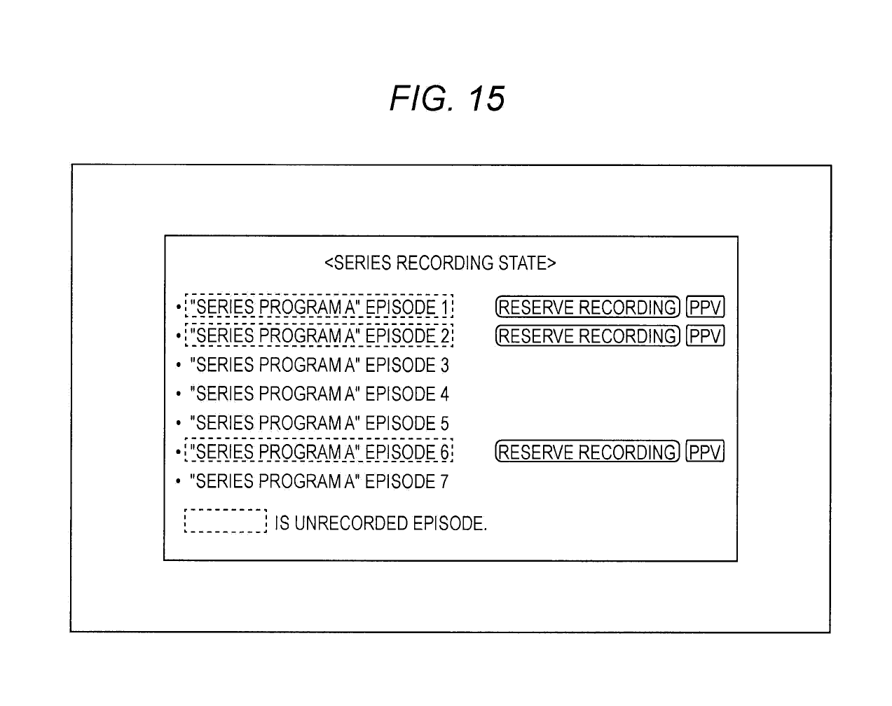

FIG. 15 is a diagram showing an example of a screen displayed by the unrecorded episode notification function.

In the example of FIG. 15, the episodes 1 to 7, which are all the episodes of the “series program A”, which is a series program, are arranged in ascending order of episode number and displayed. Among the episodes 1 to 7, the episodes 3, 4, 5, and 7 are recorded episodes and the episodes 1, 2, and 6 are unrecorded episodes.

The episodes 1, 2, and 6, which are unrecorded episodes, are surrounded by dashed lines, so that it is explicitly shown that these episodes are unrecorded episodes. In the lower part of the screen, a message indicating that an episode displayed by being surrounded by a dashed line is an unrecorded episode is displayed.

The information of an unrecorded episode and the information of a recorded episode may be displayed by different colors, such as the information of an unrecorded episode is displayed in gray and the information of a recorded episode is displayed in another color. The information of an unrecorded episode and the information of a recorded episode may be displayed in any format if they can be visually distinguished from each other.

The information of an unrecorded episode and the information of a recorded episode are displayed in different formats, so that the user can check which episodes are recorded and which episodes are unrecorded among all the episodes of a series program.

In the example of FIG. 15, buttons operated when setting a recording reservation and buttons operated when starting PPV are displayed at the right of the episodes 1, 2, and 6, which are unrecorded episodes. In this example, the “series program A” is a program for PPV.

The user of the recording device 1 can set a recording reservation of an unrecorded episode and start PPV by operating the buttons or the like. For example, when the recording control unit 32 is instructed to set a recording reservation, the recording control unit 32 sets a recording reservation based on the information of an unrecorded episode transmitted from the recording control server 3 and performs the recording.

From the screen in FIG. 15, a program request that requests broadcast of an unrecorded episode may be transmitted from the recording device 1 to the broadcast management device 4.

### About Service Subscription Guide

When the unrecorded episode is a program of pay broadcast and the user has not subscribed to a service to receive the unrecorded episode, it is possible to prompt the user to subscribe to the service on the display screen of the recording state.

In this case, the control unit 71 of the recording control server 3 determines whether or not the user of the recording device 1 has subscribed to the service to receive the unrecorded episode. If the control unit 71 determines that the user has not subscribed to the service to receive the unrecorded episode, the control unit 71 transmits information indicating that the user has not subscribed to the service as well as information of the unrecorded episode to the recording device 1.

When the display control unit 31 of the recording device 1 displays a screen as shown in FIG. 15 on the basis of the information transmitted from the recording control server 3, the display control unit 31 displays a service subscription button operated when subscribing to the service at a predetermined position, such as a position adjacent to the title of the unrecorded episode. When the service subscription button is operated, the controller 11 of the recording device 1 transmits a subscription request to subscribe to the service to receive the unrecorded episode from the broadcast date of the unrecorded episode to the broadcast management device 4 through the recording control server 3 or directly to the broadcast management device 4. The subscription request includes information of the broadcast date of the unrecorded episode.

The broadcast management device 4 processes the subscription request from the recording device 1 and makes a setting so that the recording device 1 can receive the unrecorded episode from the broadcast date of the unrecorded episode.

In this way, the recording device 1 can subscribe to the service from the broadcast date of the unrecorded episode and record the unrecorded episode by transmitting the subscription request associated with the broadcast date of the unrecorded episode.

### About Unrecorded Episode Notification Function During Disk Copy

Next, an unrecorded episode notification function during disk copy will be described.

The unrecorded episode notification function during disk copy is a function to notify that there is an unrecorded episode before performing the copy when there is an unrecorded episode even though it is instructed to copy an entire series program to another recording medium such as BD. The unrecorded episode notification function during disk copy works, for example, when a predetermined series program is selected and it is instructed to copy the entire series program.

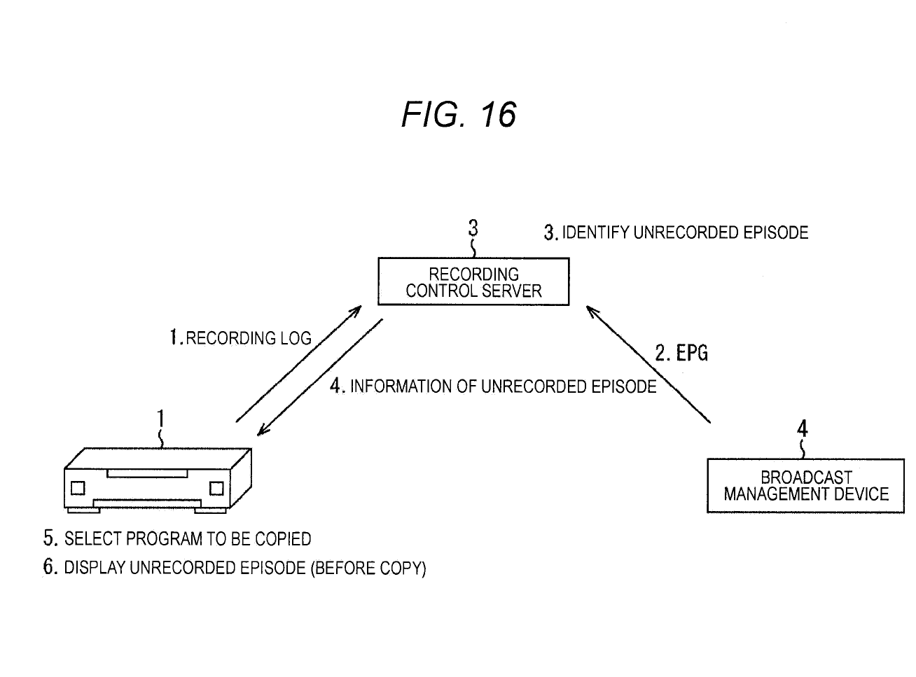

FIG. 16 is a diagram showing an example of a process flow of the unrecorded episode notification function during disk copy. Each process is performed in parallel with another process or performed before or after another process, as appropriate.

The recording device 1 generates a recording log and records the recording log every time performing recording. As shown as the process 1, the recording device 1 transmits the recording log to the recording control server 3 at a predetermined timing, such as after the recording is completed.

As shown as the process 2, the broadcast management device 4 transmits the EPG data to the recording control server 3.

The recording control server 3, which has received the recording log and the EPG data, confirms that a series program is recorded in the recording device 1 on the basis of the received information. Further, as shown as the process 3, the recording control server 3 identifies an unrecorded episode.

The recording control server 3 acquires information of the unrecorded episode from the EPG data, and as shown as the process 4, transmits the information to the recording device 1. The information transmitted to the recording device 1 includes the title, the episode number, and the like of the unrecorded episode.

The recording device 1 receives information from the recording control server 3 and causes the HDD 14 or the like to record the information. The recording device 1 can determine which episode of the recorded series program is unrecorded on the basis of the information transmitted from the recording control server 3.

As shown as the process 5, the recording device 1 selects a series program to be copied to the optical disk 21 according to user's operation. The series program to be copied to the optical disk 21 is selected by using, for example, a screen of a list of series programs.

When there is an unrecorded episode in the series program selected as a series program to be copied, as shown as the process 6, the recording device 1 causes the TV 2 to display information indicating that there is an unrecorded episode before performing the copy.

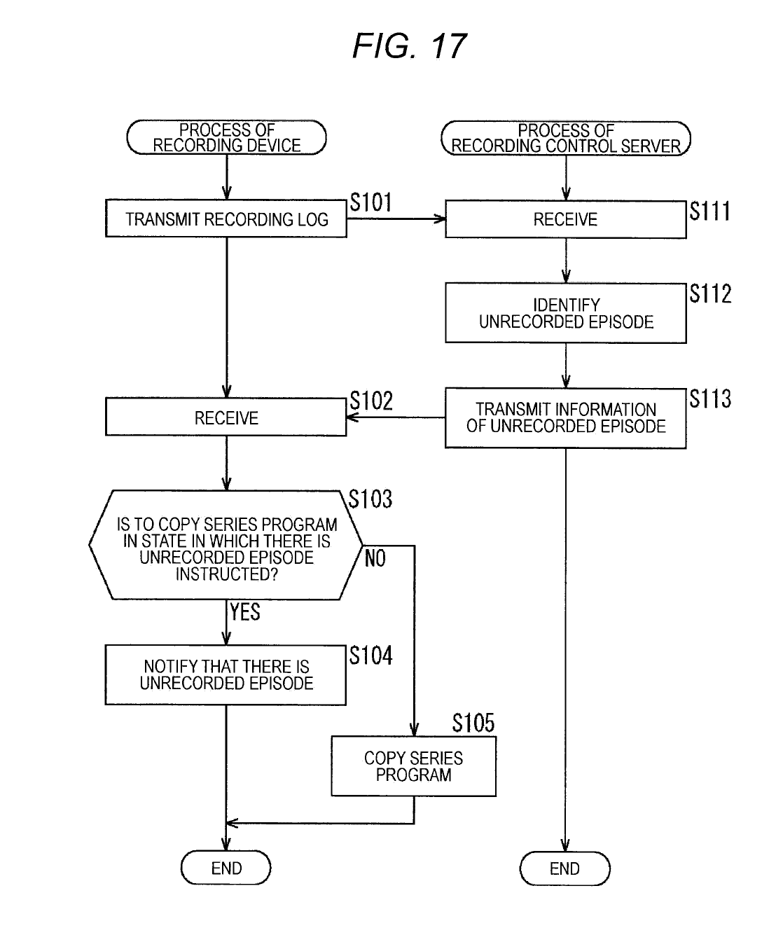

Here, the processes of the recording device 1, which notifies the user that there is an unrecorded episode by the unrecorded episode notification function during disk copy, and the recording control server 3 will be described with reference to a flowchart in FIG. 17.

The processes in FIG. 17 are started, for example, when the recording log is accumulated in the recording device 1 and the EPG data is accumulated in the recording control server 3.

In step S101, the log management unit 33 of the recording device 1 transmits the recording log accumulated in the HDD 14 or the like to the recording control server 3.

In step S111, the log acquisition unit 72 of the recording control server 3 receives and acquires the recording log transmitted from the recording device 1.

In step S112, the control unit 71 confirms that a series program is recorded in the recording device 1 on the basis of the recording log and the EPG data and identifies an unrecorded episode.

In step S113, the control unit 71 transmits information of the unrecorded episode included in the EPG data to the recording device 1.

In step S102, the display control unit 31 of the recording device 1 receives the information from the recording control server 3.

In step S103, the display control unit 31 determines whether or not it is instructed by the user to copy a series program in a state in which there is an unrecorded episode.

If the display control unit 31 determines that it is instructed to copy a series program in a state in which there is an unrecorded episode in step S103, in step S104, the display control unit 31 notifies the user that there is an unrecorded episode.

On the other hand, if the display control unit 31 determines that it is not instructed to copy a series program in a state in which there is an unrecorded episode in step S103 because the series program to be copied is a series program including no unrecorded episode, in step S105, the record control unit 15 reads all the episodes of the series program to be copied from the HDD 14 and copies all the episodes to the optical disk 21.

The process ends after the user is notified that there is an unrecorded episode in step S104 or after the series program is copied in step S105.

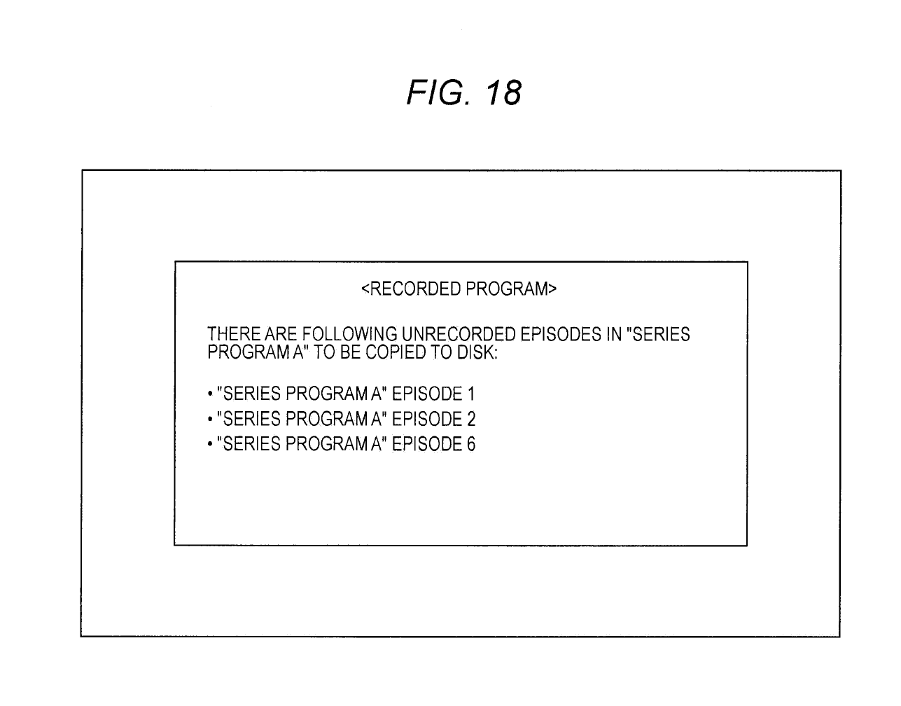

FIG. 18 is a diagram showing an example of a screen displayed by the unrecorded episode notification function during disk copy.

In the example of FIG. 18, a message notifying that the “series program A”, which is a series program instructed to be copied by the user, includes unrecorded episodes is displayed. Information indicating which episodes are unrecorded episodes is also displayed below the massage.

In this way, the user is notified that there are unrecorded episodes before copying to the optical disk 21, so that the user can prevent the series program from being copied in a state in which there are unrecorded episodes.

The user can record the unrecorded episodes by using PPV or the like after checking the notification that there are unrecorded episodes and copy the entire series program after the recording of the series program is completed. On the screen in FIG. 18, PPV for the unrecorded episodes may be guided.

### About Series Program Guide Function

Next, a series program guide function will be described.

The series program guide function is a function to automatically record the first episode (episode 1) of a series program and guide the recording of the episode 2 and the subsequent episodes.

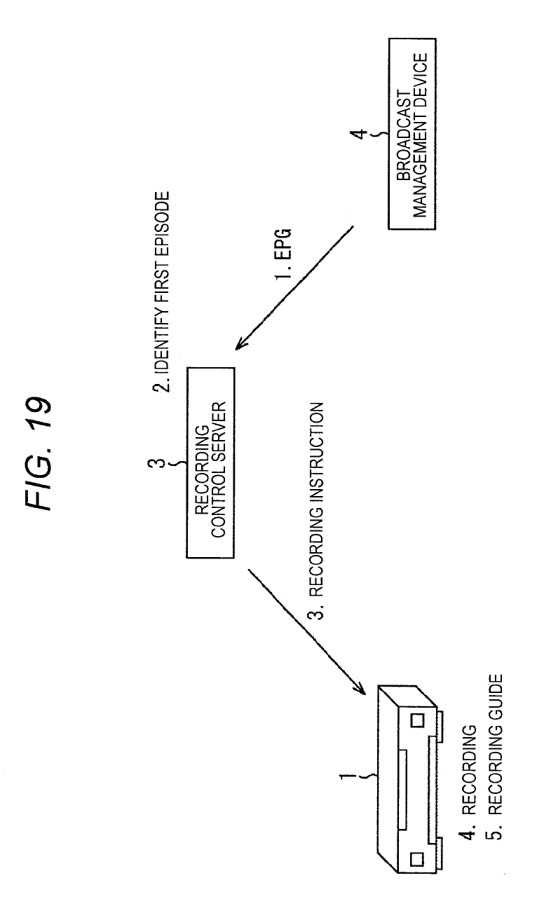

FIG. 19 is a diagram showing an example of a process flow of the series program guide function. Each process is performed in parallel with another process or performed before or after another process, as appropriate.

As shown as the process 1, the broadcast management device 4 transmits the EPG data to the recording control server 3.

As shown as the process 2, the recording control server 3, which has received the EPG data, identifies the first episode of the series program from among programs scheduled to be broadcast. As shown as the process 3, the recording control server 3 instructs the recording device 1 to record the identified first episode. The instruction transmitted from the recording control server 3 to the recording device 1 includes the broadcast date and time and the channel of the first episode included in the EPG data.

The recording device 1 receives the instruction from the recording control server 3 and sets a recording reservation of the first episode instructed to be recorded. When the broadcast of the first episode is started, as shown as the process 4, the recording device 1 records the first episode of the series program.

When the recording of the first episode of the series program is completed, as shown as the process 5, the recording device 1 guides the recording of the episode 2 and the subsequent episodes.

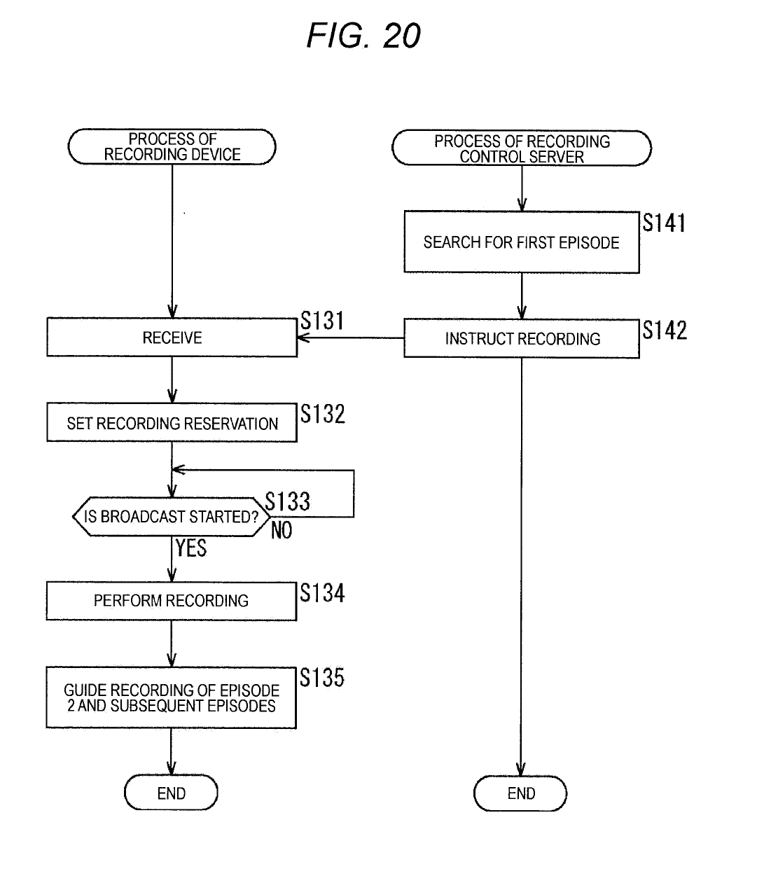

Here, the processes of the recording device 1, which guides the recording of a series program by the series program guide function, and the recording control server 3 will be described with reference to a flowchart in FIG. 20. The processes in FIG. 20 are started, for example, when the EPG data is accumulated in the recording control server 3.

In step S141, the search unit 73 of the recording control server 3 searches for the first episode of the series program from among programs scheduled to be broadcast on the basis of the EPG data.

In step S142, the control unit 71 transmits information including the broadcast date and time and the channel of the first episode searched by the search unit 73 to the recording device 1 and instructs the recording device 1 to record the first episode.

In step S131, the recording control unit 32 of the recording device 1 receives a recording instruction from the recording control server 3, and in step S132, the recording control unit 32 sets a recording reservation of the episode instructed to be recorded.

In step S133 the recording control unit 32 determines whether or not it is the broadcast start time of the first episode and waits until the recording control unit 32 determines that it is the broadcast start time.

If the recording control unit 32 determines that it is the broadcast start time of the first episode in step S133, in step S134, the recording control unit 32 controls the broadcast receiving unit 12 and the recording processing unit 13 and causes the broadcast receiving unit 12 and the recording processing unit 13 to record the first episode whose broadcast is started.

When the recording of the first episode is completed, in step S135, the display control unit 31 guides the recording of the episode 2 and the subsequent episodes by causing the TV 2 to display a message and then ends the process.

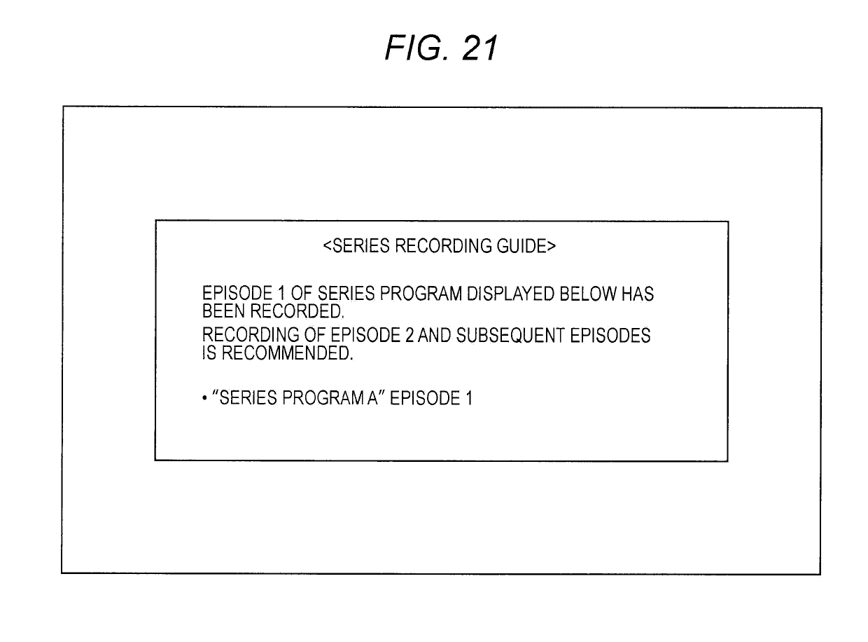

FIG. 21 is a diagram showing an example of a screen displayed by the series program guide function.

On the screen in FIG. 21, a message is displayed which notifies that the first episode of the “series program A”, which is a series program, was automatically recorded and guides the recording of the episode 2 and the subsequent episodes.

Thereby, the user can prevent the user from forgetting the recording of the first episode and the user can complete the recording of the series program by checking the guide and setting a recording reservation of the episode 2 and the subsequent episodes.

### Modified Example

In the above description, the recording device 1 performs processing according to control of the recording control server 3 and thereby each function is implemented. However, each function may be implemented in a single body of the recording device 1. In this case, the configuration in FIG. 4 is provided in the recording device 1.

The case has been described in which recording of a series program including a plurality of episodes is completed. However, the present technique can be applied to a case in which recording of an entire group of programs having a predetermined relevance to each other, such as programs of the same title and programs of the same category, is completed. The present technique is not limited to recording of broadcast programs, but can be also applied to recording an entire group of music having a predetermined relevance to each other, such as musical compositions included in the same album.

The complementary recording may be performed by using programs whose broadcast modes are different from each other, such as when a series program broadcast by terrestrial television broadcasting is recorded, an unrecorded episode is complementarily recorded by using a program of satellite television broadcasting. When a series program broadcast by satellite television broadcasting is recorded, an unrecorded episode can also be complementarily recorded by using a program of terrestrial television broadcasting.

### About Program

The series of processes described above can be performed by hardware or can be performed by software. When the series of processes is performed by software, a program forming the software is installed in a computer included in dedicated hardware or a general-purpose personal computer.

The program to be installed is provided by recording in the removable medium 59 shown in FIG. 3, which is formed of an optical disk (CD-ROM (Compact Disc-Read Only Memory), DVD (Digital Versatile Disc), and the like) or a semiconductor memory. The program may be provided through a wired or wireless transmission medium such as a local area network, the Internet, or digital broadcasting. The program can be installed in the ROM 52 or the HDD 56 in advance.

The program executed by the computer may be a program where processes are performed in time series along the sequence described in the present description or may be a program where processes are performed in parallel or performed at a necessary timing such as when being called.

The embodiment of the present technique is not limited to the embodiment described above and can be variously modified without departing from the scope of the present technique.

### Combination Example of Configurations

The present technique can have configurations as described below.

(1)

A control device including:

an acquisition unit that acquires information of a program recorded in a recording device; and

a control unit that controls recording in the recording device so that an unrecorded episode is recorded when there is the unrecorded episode in a series program recorded in the recording device.

(2)

The control device according to (1), wherein

the control unit determines whether or not the unrecorded episode is scheduled to be broadcast on the basis of EPG data and when determining that the unrecorded episode is scheduled to be broadcast, the control unit transmits information including broadcast date and time of the unrecorded episode to the recording device and causes the recording device to set a recording reservation of the unrecorded episode.

(3)

The control device according to (2), wherein

when the control unit determines that the unrecorded episode is not scheduled to be broadcast, the control unit transmits a request for broadcast of the unrecorded episode to a broadcast management device that manages broadcast of the series program.

(4)

The control device according to any of (1) to (3), wherein

the control unit identifies a scheduled recording completion date of the series program on the basis of EPG data and transmits information of the scheduled recording completion date to the recording device.

(5)

The control device according to any of (1) to (3), further including:

a search unit that searches for a first episode of a predetermined series program from among programs which are scheduled to be broadcast and whose program information is included in EPG data,

wherein the control unit transmits information including broadcast date and time of the first episode of the predetermined series program to the recording device and causes the recording device to record the first episode.

(6)

The control device according to any of (1) to (5), wherein

the acquisition unit acquires information of a program deleted in the recording device, and

the control unit controls recording in the recording device so that the unrecorded episodes other than the episode deleted in the recording device among the unrecorded episodes are recorded.

(7)

A control method including the steps of:

acquiring information of a program recorded in a recording device; and

controlling recording in the recording device so that an unrecorded episode is recorded when there is the unrecorded episode in a series program recorded in the recording device.

(8)

A program causing a computer to execute a process including the steps of:

acquiring information of a program recorded in a recording device; and

controlling recording in the recording device so that an unrecorded episode is recorded when there is the unrecorded episode in a series program recorded in the recording device.

(9)

A recording device including:

a transmission unit that transmits information of a recorded program to a control device; and

a recording control unit that records an unrecorded episode according to control performed by the control device when there is the unrecorded episode in a series program that is recorded.

(10)

The recording device according to (9), wherein

the recording control unit sets a recording reservation of the unrecorded episode on the basis of information including broadcast date and time of the unrecorded episode transmitted from the control device.

(11)

The recording device according to (9) or (10), further including:

a display control unit that displays a scheduled recording completion date of the series program on the basis of information transmitted from the control device.

(12)

The recording device according to (9) or (10), wherein

the recording control unit records a first episode of a predetermined series program on the basis of information including broadcast date and time of the first episode of the predetermined series program transmitted from the control device, and

the recording device further includes a display control unit that displays information guiding recording of the first episode and the subsequent episodes when recording of the first episode is performed.

(13)

The recording device according to (9) or (10), further including:

a display control unit that displays information of the unrecorded episode in a format different from that of information of a recorded episode along with the information of the recorded episode.

(14)

The recording device according to (9) or (10), further including:

a record control unit that causes a recording medium to record a recorded program; and

a display control unit that displays information indicating that there is the unrecorded episode before the series program is recorded when the series program is selected as a program to be recorded in the recording medium.

(15)

The recording device according to any of (9) to (14), wherein

the transmission unit transmits information of a deleted program to the control device, and

the recording control unit records the unrecorded episodes other than the deleted episode among the unrecorded episodes according to control performed by the control device.

(16)

The recording device according to any of (9) to (15), wherein

when it is necessary to subscribe to a predetermined service to receive the unrecorded episode, the transmission unit transmits a request to subscribe to the service from a broadcast date of the unrecorded episode on the basis of information including the broadcast date of the unrecorded episode transmitted from the control device.

(17)

A recording method including the steps of:

transmitting information of a recorded program to a control device; and

recording an unrecorded episode according to control performed by the control device when there is the unrecorded episode in a series program that is recorded.

(18)

A program causing a computer to execute a process including the steps of:

transmitting information of a recorded program to a control device; and

recording an unrecorded episode according to control performed by the control device when there is the unrecorded episode in a series program that is recorded.

### REFERENCE SIGNS LIST

1 Recording device
2 TV
3 Recording control server
4 Broadcast management device
31 Display control unit
32 Recording control unit
33 Log management unit
71 Control unit
72 Log management unit
73 Search unit

1. A control device comprising:
an acquisition unit that acquires information of a program recorded in a recording device; and
a control unit that controls recording in the recording device so that an unrecorded episode is recorded when there is the unrecorded episode in a series program recorded in the recording device.

2. The control device according to claim 1, wherein
the control unit determines whether or not the unrecorded episode is scheduled to be broadcast on the basis of EPG data and when determining that the unrecorded episode is scheduled to be broadcast, the control unit transmits information including broadcast date and time of the unrecorded episode to the recording device and causes the recording device to set a recording reservation of the unrecorded episode.

3. The control device according to claim 2, wherein
when the control unit determines that the unrecorded episode is not scheduled to be broadcast, the control unit transmits a request for broadcast of the unrecorded episode to a broadcast management device that manages broadcast of the series program.

4. The control device according to claim 1, wherein
the control unit identifies a scheduled recording completion date of the series program on the basis of EPG data and transmits information of the scheduled recording completion date to the recording device.

5. The control device according to claim 1, further comprising:
a search unit that searches for a first episode of a predetermined series program from among programs which are scheduled to be broadcast and whose program information is included in EPG data,
wherein the control unit transmits information including broadcast date and time of the first episode of the predetermined series program to the recording device and causes the recording device to record the first episode.

6. The control device according to claim 1, wherein
the acquisition unit acquires information of a program deleted in the recording device, and
the control unit controls recording in the recording device so that the unrecorded episodes other than the episode deleted in the recording device among the unrecorded episodes are recorded.

7. A control method comprising the steps of:
acquiring information of a program recorded in a recording device; and
controlling recording in the recording device so that an unrecorded episode is recorded when there is the unrecorded episode in a series program recorded in the recording device.

8. A program causing a computer to execute a process including the steps of:
acquiring information of a program recorded in a recording device; and
controlling recording in the recording device so that an unrecorded episode is recorded when there is the unrecorded episode in a series program recorded in the recording device.

9. A recording device comprising:
a transmission unit that transmits information of a recorded program to a control device; and
a recording control unit that records an unrecorded episode according to control performed by the control device when there is the unrecorded episode in a series program that is recorded.

10. The recording device according to claim 9, wherein
the recording control unit sets a recording reservation of the unrecorded episode on the basis of information including broadcast date and time of the unrecorded episode transmitted from the control device.

11. The recording device according to claim 9, further comprising:
a display control unit that displays a scheduled recording completion date of the series program on the basis of information transmitted from the control device.

12. The recording device according to claim 9, wherein
the recording control unit records a first episode of a predetermined series program on the basis of information including broadcast date and time of the first episode of the predetermined series program transmitted from the control device, and
the recording device further includes a display control unit that displays information guiding recording of the first episode and the subsequent episodes when recording of the first episode is performed.

13. The recording device according to claim 9, further comprising:
a display control unit that displays information of the unrecorded episode in a format different from that of information of a recorded episode along with the information of the recorded episode.

14. The recording device according to claim 9, further comprising:
a record control unit that causes a recording medium to record a recorded program; and
a display control unit that displays information indicating that there is the unrecorded episode before the series program is recorded when the series program is selected as a program to be recorded in the recording medium.

15. The recording device according to claim 9, wherein
the transmission unit transmits information of a deleted program to the control device, and
the recording control unit records the unrecorded episodes other than the deleted episode among the unrecorded episodes according to control performed by the control device.

16. The recording device according to claim 9, wherein
when it is necessary to subscribe to a predetermined service to receive the unrecorded episode, the transmission unit transmits a request to subscribe to the service from a broadcast date of the unrecorded episode on the basis of information including the broadcast date of the unrecorded episode transmitted from the control device.

17. A recording method comprising the steps of:
transmitting information of a recorded program to a control device; and
recording an unrecorded episode according to control performed by the control device when there is the unrecorded episode in a series program that is recorded.

18. A program causing a computer to execute a process including the steps of:
transmitting information of a recorded program to a control device; and
recording an unrecorded episode according to control performed by the control device when there is the unrecorded episode in a series program that is recorded.
